(19) United States
(12) Patent Application Publication
(10) Pub. No.: US 2006/0143624 A1
(43) Pub. Date: Jun. 29, 2006

(54) Disc drive apparatus with guiding ribs

(75) Inventor: Bin-Hai Guo, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/303,359

(22) Filed: Dec. 16, 2005

(30) Foreign Application Priority Data
Dec. 29, 2004 (CN) 200420103542.3

(51) Int. Cl. G11B 17/04; G11B 17/03; G11B 33/02

(52) U.S. Cl. 720/613

(57) ABSTRACT

A disc drive apparatus for reproducing/recording information on a disc, the disc drive apparatus includes a frame and a tray slidably received in the frame. The frame has a plurality of guiding ribs. The frame has a back and an open front. The tray is slidable along a moving direction corresponding to a loading direction of insertion of the tray into the frame. The tray has a back and a front. The back of the tray is initially received in the front of the frame and thereby moving toward the back of the frame when proceeding in the loading direction. The tray defines a disc recess therein configured for receiving and holding the disc therein. The tray defines a pair of guiding slots extending along the moving direction from the back of the tray. The guiding slots parallel to each other selectively receive the guiding ribs of the frame.

### BACKGROUND

1. Field of the Invention

The present invention generally relates to disc drive apparatus and, more particularly, to a disc drive apparatus with a steady loading characteristic.

2. Related Art

With developments of information technology and widespread utilization of multimedia contents, demand for data storage solutions with high capacities and low costs rises day by day. Among all the data storage solutions, discs are becoming more and more important for backing up data and exchanging information, due to many advantages that the optical storage media have. Such advantages include a high data capacity, portability, and a long lifetime for preserving information. Currently, the disc drives are widely used in such devices as desktop computers, laptop computers, DVD players, and some instruments or electronic products with built-in microprocessors.

Generally speaking, a disc drive loads or ejects a disc by utilizing a disc loading mechanism thereof. After being loaded into the disc drive, the disc is fixed to a turntable of a spindle motor for further data access. The disc loading mechanism entails placing the disc onto a disc loading tray while the tray is in a projected position with respect to a base of the disc drive and then moving the tray to a received position to load the disc within the disc drive. In a conventional disc drive, the disc loading tray is typically driven by a load motor to move the tray between the projected and received positions. Once the tray is moved to the received position, the disc is lifted from the disc loading tray, as the base, from which a spindle motor and a pickup are attached thereto, is raised. The disc is then grasped by a clamping device and supported by the turntable operatively associated with the spindle motor. The pickup is then moved to a data reading/writing position by a feed motor to perform a data reading or writing operation.

While moving into and/or out from the disc drive, the tray is guided in a vertical direction by several blocks, but the tray is probably not guided as well (if at all) in a horizontal direction. Therefore, vibration or shaking in the horizontal direction can be much more serious than in the vertical direction.

Accordingly, a need exists for a disc drive apparatus in the industry to address the aforementioned deficiencies and inadequacies.

### SUMMARY

Briefly described, one embodiment of a disc drive apparatus provides horizontal guidance for the disc tray, in addition to vertical guidance, and is thereby able reduce or potentially eliminate shaking and/or vibrations experienced by the disc drive apparatus.

A disc drive apparatus for reproducing/recording information on a disc, the disc drive apparatus includes a frame and a tray slidably received in the frame. The frame has a plurality of guiding ribs defined thereon. The frame has a back and an open front. The tray is slidable along a moving direction corresponding to a loading direction of insertion of the tray into the frame. The tray has a back and a front. The back of the tray is initially received in the front of the frame and thereby moving toward the back of the frame when proceeding in the loading direction. The tray defines a disc recess therein configured for receiving and holding the disc therein. The tray defines at least a pair of guiding slots extending along the moving direction from the back of the tray. The pair of guiding slots parallel to each other selectively receives the guiding ribs of the frame.

Other systems, methods, features, and advantages of the present disc drive apparatus will be or become apparent to one with skill in the art upon examination of the following drawings and detailed description. It is intended that all such additional systems, methods, features, and advantages be included within this description, be within the scope of the present apparatus, and be protected by the accompanying claims.

### BRIEF DESCRIPTION OF THE DRAWINGS

Many aspects of the present disc drive apparatus can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is an exploded, isometric view of a disc drive apparatus in accordance with an exemplary embodiment thereof;

FIG. 2 is an exploded, isometric view of the disc drive apparatus of FIG. 1, viewed from another aspect;

FIG. 3 is an isometric view of a tray of FIG. 1, viewed from a bottom aspect; and

FIG. 4 is an enlarged view of a circled portion IV of FIG. 1.

### DETAILED DESCRIPTION OF PREFERRED EMBODIMENTS

Reference will now be made to the drawing figures to describe the preferred embodiments of the present disc drive apparatus, in detail.

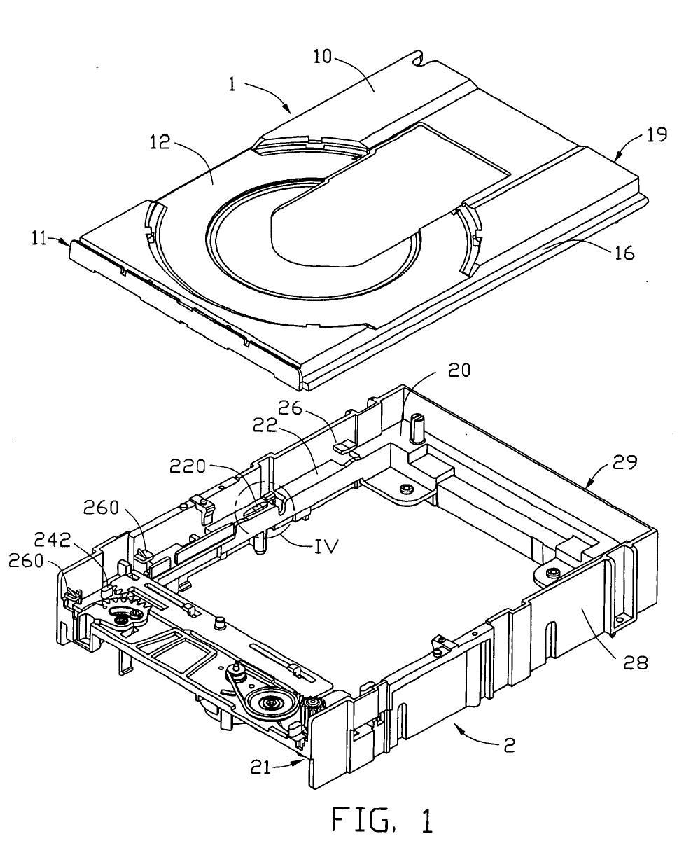

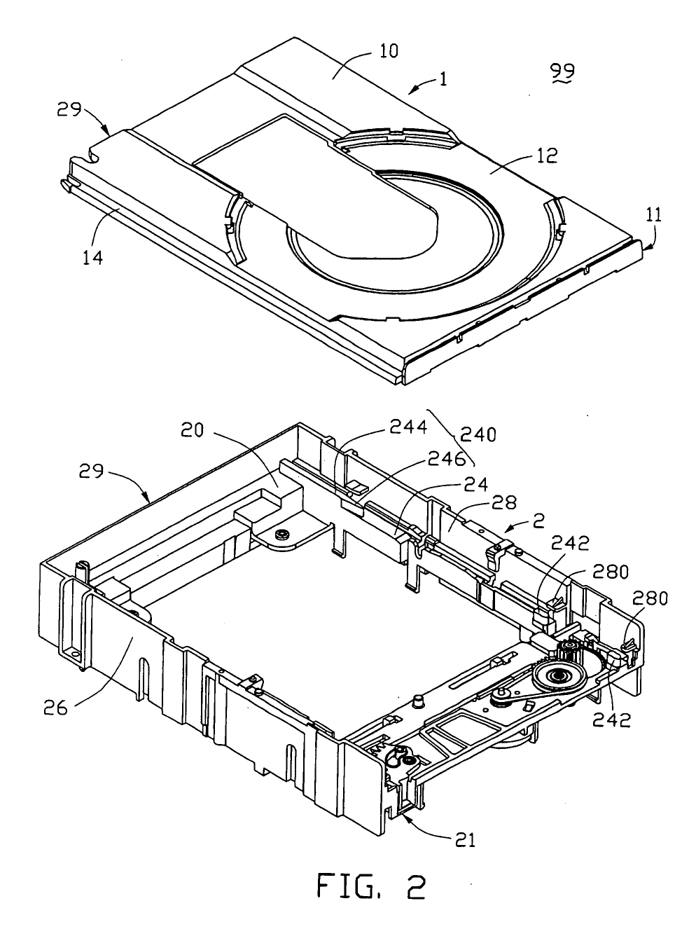

Referring to FIG. 1 and FIG. 2 together, an exploded view of a disc drive 99, in accordance with an exemplary embodiment of the present disc drive, is illustrated. The disc drive 99 includes a tray 1 and a frame 2. The tray 1 slides into/out from the frame 2 to convey a disc (not shown) thereon.

The tray 1 defines a horizontal main body 10 and generally includes a tray front 11 and a tray back 19. The tray back 19 generally enters first into the frame 2 upon loading, while the tray front 11 is first to exit during unloading. A substantial round depression extending down from a top plane of the main body 10 defines a disc recess 12 configured for receiving and holding the disc therein. A first guiding plate 14 and a second guiding plate 16, parallel to the top plane of the main body 10, extend along a moving direction of the tray 1. The first guiding plate 14 and the second guiding plate 16 are respectively positioned at two opposite sides of the disc recess 12 and are configured for guiding horizontal movement of the tray 1.

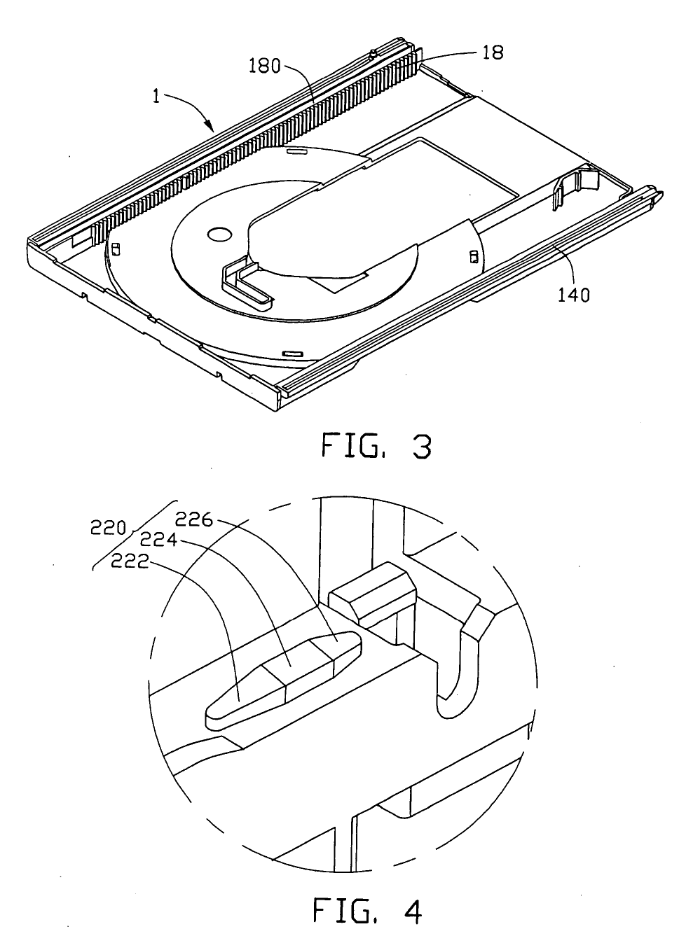

Also referring to FIG. 3, a first guiding slot 140 begins at a back of the first guiding plate 14 and extends along the moving direction of the tray 1. A second guiding slot 180 starts at a back of the second guiding plate 16 and then extends, in the same way as the first guiding slot 140. Additionally, a driving rack 18 extends along the moving direction of the tray 1, nearly running the length of the tray 1.

Referring to FIG. 1 and FIG. 2 again, the frame 2 defines a rectangular supporting stage 20 in a horizontal plane (i.e., essentially parallel to the tray 1). The frame 2 has an open front 21 and an enclosed back 29. The front 21 is configured to facilitate ingress and egress of the tray 1 during loading/unloading of the disk. The supporting stage 20 includes a first supporting plate 22 and a second supporting plate 24, with such plates 22, 24 extending parallel to each other and parallel to the loading direction of the tray 1. The first supporting plate 22 and the second supporting plate 24 oppose to each other and respectively face and support the first guiding plate 14 and the second guiding plate 16 of the tray 1 thereon. A first side wall 26 and a second side wall 28 are respectively formed at two opposite sides of the supporting stage 20 to thus sandwich the supporting stage 20 therebetween. The first side wall 26 is perpendicularly adjacent to the first supporting plate 22, and the second side wall 28 is perpendicularly adjacent to the second supporting plate 24. A plurality of first limiting blocks 260 and a plurality of second limiting blocks 280, respectively, extend inwardly from inner surfaces of the first side wall 26 and the second side wall 28. A pair of guiding passages (not labeled) is respectively defined between the plurality of first limiting blocks 260 and the first supporting plate 22 and between the plurality of second limiting blocks 280 and the second supporting plate 24. These guiding passages accordingly limit the first guiding plate 14 and the second guiding plate 16 of the tray 1. That is, the first and the second guiding plates 14, 16 of the tray 1 are slideably received in the guiding passages defined between the first and second limiting blocks 260, 280 and the supporting stage 20.

A first guiding rib 220, configured for being received in the first guiding slot 140 of the tray 1, protrudes from a middle of the first supporting plate 22, while a third guiding rib 242 protrudes from a front of the first supporting plate 22. A second guiding rib 240 and several third guiding ribs 242, configured for being received in the second guiding slot 160 of the tray 1, respectively, protrude from a front and a back of the second supporting plate 24.

Now, referring to FIG. 4, the first guiding rib 220 includes a first guide-in portion 222, a first guide-out portion 226, and a first host portion 224, the first host portion 224 evenly connecting the first guide-in portion 222 and the first guide-out portion 226. The first guiding rib 220 is positioned along the moving direction of the tray 1. The first guide-in portion 222 has a gradually increasing width, with respect to the loading direction of the tray, to guide the first guiding plate 14 of the tray 1 to the first host portion 224. Conversely, the guide-out portion 226 has a gradually decreasing width, relative to the loading direction. The first host portion 224 has a width generally equal to that of a widest portion of each of the first guide-in portion 222 and the first guide-out portion 226.

Referring to FIG. 2 again, the second guiding rib 240, positioned at the back of the second supporting plate 24, includes a second guide-in portion 246 and a second host portion 244 joined with the second guide-in portion 246. Similar to the first guide-in portion 222, the second guide-in portion 246 has a gradually increasing width to guide the second guiding plate 16 to the second host portion 244.

When loading a disc into the disc drive 99, the tray 1 receives the disc in the disc recess 12. Owing to the driving rack 18, which is operatively coupled with a power source, the tray 1 with the disc thereon is driven into the frame 2. As the third guiding ribs 242 are received in the first and second guiding slots 140, 160, the tray 1 moves along the third guiding ribs 242. At the time of reaching the first guiding rib 220, the first guide-in portion 220 enters the first guiding slot 140, in advance of the first host portion 224. A tip of the first guide-in portion 222 easily engages the first guiding slot 140, due to a smaller width thereof. Along with the movement, the first host portion 224 and the first guide-out portion 226 of the first guiding rib 220 gradually become inserted into the first guiding slot 140. In further progress, the tray 1 arrives at the second guiding rib 240. The second guide-in portion 246 of the second guiding rib 240 enters the second guiding slot 160 in advance of the second host portion 244. A tip of the second guide-in portion 246 easily enters the second guiding slot 160, due to a smaller width thereof. After the second host portion 244 wholly inserts through the second guiding slot 244, the tray I is sufficiently located at a loading position. The disc on the tray 1 is loaded and reproduced/recorded.

When unloading a disc from the disc drive 99 (i.e., moving in the opposing unloading direction), a reverse operation is performed.

As a result of the first and second guiding ribs 220, 240, the tray 1 is efficiently guided, and the tray 1 avoids vibrating in a horizontal direction during a loading/unloading process. Therefore, the disc drive 99 presents a high performance device featuring minimized vibrations. Also, the presence of the various ribs 220, 240 and the corresponding guiding slots 140, 180 provides increased lateral stability both during disk loading and unloading and during operation. As such, the disc drive 99 is less susceptible to the effects of potential movement of the unit itself (i.e., as part of a computer assembly), not just to the movement of the tray 1 relative to the frame 2 during loading/unloading. Accordingly, the disc drive 99 could prove to be especially useful in, e.g., laptops, where the potential for jiggling of the disc drive 99 during use may often be a concern (e.g., during traveling).

It should be emphasized that the above-described embodiments of the present invention, including any preferred embodiments, are merely possible examples of implementation of the principles of the invention, and are merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and be protected by the following claims.

What is claimed is:

1. A disc drive apparatus for reproducing/recording information on a disc, said disc drive apparatus comprising:
a frame including a plurality of guiding ribs thereon, the frame having a back and front, the front of the frame being open; and
a tray being slideably received in said frame along a moving direction corresponding to a loading direction of insertion of said tray into said frame and said disc drive apparatus, said tray having a back and a front, said back of said tray being initially received in said front of said frame and thereby moving toward said back of said frame when proceeding in the loading direction, said tray defining a disc recess therein, the disc recess being configured for receiving and holding the disc therein, said tray defining at least a pair of guiding slots extending along the moving direction from said back of said tray, said pair of guiding slots being parallel to each other, said pair of guiding slots selectively receiving said guiding ribs of said frame.

2. The disc drive apparatus according to claim 1, wherein said plurality of guiding ribs comprises a first guiding rib and a second guiding rib engageable with a respective one of said pair of guiding slots.

3. The disc drive apparatus according to claim 2, wherein said first guiding rib comprises a first guide-in portion, and said first guide-in portion provides a gradually increasing width along the loading direction.

4. The disc drive apparatus according to claim 3, wherein said first guiding rib further comprises a first host portion connecting with said first host portion, and said first host portion provides a width substantially equal to that of a widest portion of said first guide-in portion.

5. The disc drive apparatus according to claim 4, wherein said first guiding rib further comprises a first guide-out portion, and said first guide-out portion provides a gradually decreasing width along the loading direction of said tray.

6. The disc drive apparatus according to claim 2, wherein said first guiding rib is formed at a middle of said frame along the loading direction.

7. The disc drive apparatus according to claim 2, wherein said second guiding rib comprises a second guide-in portion, and said second guide-in portion provides a gradually increasing width along the loading direction.

8. The disc drive apparatus according to claim 7, wherein said second guiding rib further comprises a second host portion, and said second host portion provides a width substantially equal to that of a widest portion of said second guide-in portion.

9. The disc drive apparatus according to claim 7, wherein said second guiding rib is formed at said back of said frame, along the loading direction.

10. The disc drive apparatus according to claim 1, wherein said frame includes a pair of supporting plates, said supporting plates being located at respective opposing sides of said frame, said supporting plates extending in the moving direction of said tray, said supporting plates carrying said tray thereon, each said supporting plate having at least one said guiding rib thereon, each guiding rib being configured for engagement with a respective said guiding slot of said tray.

11. The disc drive apparatus according to claim 10, wherein each said supporting plate has a plurality of said guiding ribs formed thereon.
